(19) United States
(12) Patent Application Publication
(10) Pub. No.: US 2018/0075526 A1
(43) Pub. Date: Mar. 15, 2018

(54) ASSET EXCHANGE SYSTEM AND METHOD

(71) Applicant: MonetaGo Inc., New York, NY (US)

(72) Inventors: Jesse R. Chenard, New York, NY (US); Patrick E. Manasse, New York, NY (US); Paul R. Davis, III, Jersey City, NJ (US); Brendan L. Taylor, New York, NY (US)

(21) Appl. No.: 15/699,705

(22) Filed: Sep. 8, 2017

Related U.S. Application Data
(60) Provisional application No. 62/385,517, filed on Sep. 9, 2016.
(60) Provisional application No. 62/385,533, filed on Sep. 9, 2016.

(51) Int. Cl. G06Q 40/02

(52) U.S. Cl. CPC G06Q 40/02

(57) ABSTRACT

A computer-implemented method, computer program product and computing system for maintaining a distributed account ledger for a plurality of banks that are associated with a central bank. An asset exchange between the plurality of banks is processed and the distributed account ledger is updated to memorialize the asset exchange between the plurality of banks.

### RELATED APPLICATION(S)

This application claims the benefit of U.S. Provisional Application No. 62/385,517, filed on 9 Sep. 2016, and U.S. Provisional Application No. 62/385,533, filed on 9 Sep. 2016; the contents of which are incorporated herein by reference.

### TECHNICAL FIELD

This disclosure relates to asset exchange systems and, more particularly, to asset exchange systems that utilize a ledger system.

### BACKGROUND

Businesses function in a global economy and assets are often transferred between these companies, wherein such transfers may cross international borders. Accordingly, a first company in a first country may invoice a second company in a second country, wherein payments may be made by transferring assets (e.g., funds) from a bank account of the second company in the second country to a bank account of the first company in the first country.

Unfortunately, such cross-border transactions are often slow to effectuate for various reasons. For example, many individual entities (e.g., banks) may be involved that may require multiple discrete transfers in order to effectuate the complete transfer. Additionally, each one of these discrete transfers may induce a delay, as the individual entities may wait for their transfer to settle before the next transfer may begin.

### SUMMARY OF DISCLOSURE

In one implementation, a computer-implemented method is executed on a computing device and includes maintaining a distributed account ledger for a plurality of banks that are associated with a central bank. An asset exchange between the plurality of banks is processed and the distributed account ledger is updated to memorialize the asset exchange between the plurality of banks.

One or more of the following features may be included. Maintaining a distributed account ledger for the plurality of banks that are associated with the central bank may include maintaining a copy of the distributed account ledger on each of the plurality of banks and the central bank, thus defining a plurality of copies of the distributed account ledger. Updating the distributed account ledger to memorialize the asset exchange between the plurality of banks may include updating one or more of the plurality of copies of the distributed account ledger in response to processing the asset exchange between the plurality of banks. The central bank may maintain an account for each of the plurality of banks, thus defining a plurality of accounts. The assets included in one or more of the plurality of accounts may be adjusted. Maintaining a distributed account ledger for the plurality of banks that are associated with the central bank may include defining a quantity of assets included in each of the plurality of accounts. Maintaining a distributed account ledger for the plurality of banks that are associated with the central bank may include reconciling the quantity of assets included in each of the plurality of accounts in response to one or more of the plurality of banks and the central bank having been unavailable. The plurality of banks may include at least one commercial bank. The distributed account ledger may include a blockchain ledger.

In another implementation, a computer program product resides on a computer readable medium and has a plurality of instructions stored on it. When executed by a processor, the instructions cause the processor to perform operations including maintaining a distributed account ledger for a plurality of banks that are associated with a central bank. An asset exchange between the plurality of banks is processed and the distributed account ledger is updated to memorialize the asset exchange between the plurality of banks.

One or more of the following features may be included. Maintaining a distributed account ledger for the plurality of banks that are associated with the central bank may include maintaining a copy of the distributed account ledger on each of the plurality of banks and the central bank, thus defining a plurality of copies of the distributed account ledger. Updating the distributed account ledger to memorialize the asset exchange between the plurality of banks may include updating one or more of the plurality of copies of the distributed account ledger in response to processing the asset exchange between the plurality of banks. The central bank may maintain an account for each of the plurality of banks, thus defining a plurality of accounts. The assets included in one or more of the plurality of accounts may be adjusted. Maintaining a distributed account ledger for the plurality of banks that are associated with the central bank may include defining a quantity of assets included in each of the plurality of accounts. Maintaining a distributed account ledger for the plurality of banks that are associated with the central bank may include reconciling the quantity of assets included in each of the plurality of accounts in response to one or more of the plurality of banks and the central bank having been unavailable. The plurality of banks may include at least one commercial bank. The distributed account ledger may include a blockchain ledger.

In another implementation, a computing system including a processor and memory is configured to perform operations including maintaining a distributed account ledger for a plurality of banks that are associated with a central bank. An asset exchange between the plurality of banks is processed and the distributed account ledger is updated to memorialize the asset exchange between the plurality of banks.

One or more of the following features may be included. Maintaining a distributed account ledger for the plurality of banks that are associated with the central bank may include maintaining a copy of the distributed account ledger on each of the plurality of banks and the central bank, thus defining a plurality of copies of the distributed account ledger. Updating the distributed account ledger to memorialize the asset exchange between the plurality of banks may include updating one or more of the plurality of copies of the distributed account ledger in response to processing the asset exchange between the plurality of banks. The central bank may maintain an account for each of the plurality of banks, thus defining a plurality of accounts. The assets included in one or more of the plurality of accounts may be adjusted. Maintaining a distributed account ledger for the plurality of banks that are associated with the central bank may include defining a quantity of assets included in each of the plurality of accounts. Maintaining a distributed account ledger for the plurality of banks that are associated with the central bank may include reconciling the quantity of assets included in each of the plurality of accounts in response to one or more of the plurality of banks and the central bank having been unavailable. The plurality of banks may include at least one commercial bank. The distributed account ledger may include a blockchain ledger.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an asset exchange process according to an embodiment of the present disclosure;

FIG. 2 is a flowchart of an implementation of the asset exchange process of FIG. 1 according to an embodiment of the present disclosure; and

FIG. 3 is a flowchart of another implementation of the asset exchange process of FIG. 1 according to an embodiment of the present disclosure.

Like reference symbols in the various drawings indicate like elements.

### DETAILED DESCRIPTION OF THE PREFERRED EMBODIMENTS

System Overview

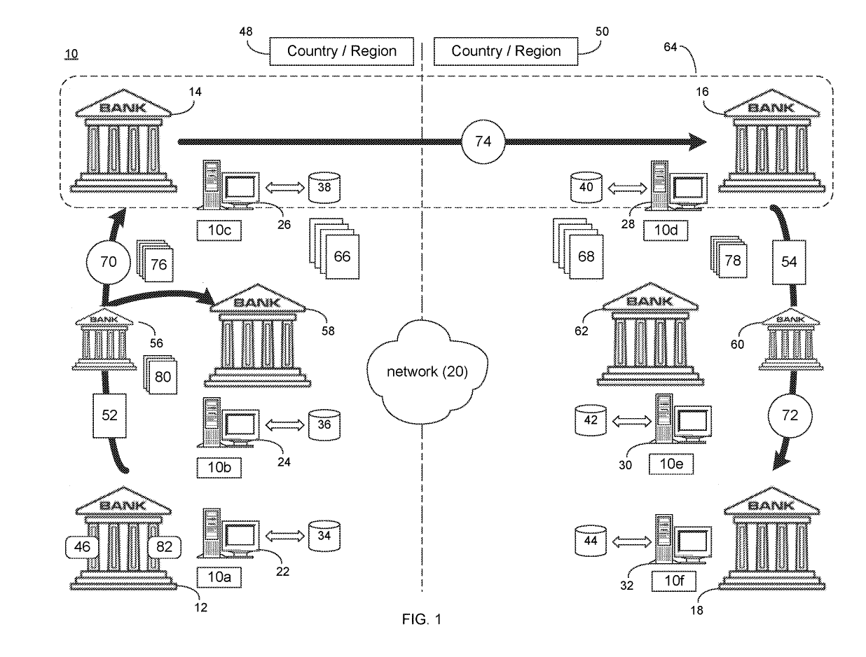

Referring to FIG. 1, there is shown asset exchange process 10. As will be discussed below in greater detail, asset exchange process 10 may be configured to effectuate an asset exchange between a plurality of banks. Examples of such a plurality of banks may include but are not limited to commercial bank 12, commercial bank 14, commercial bank 16, and commercial bank 18.

Asset exchange process 10 may be implemented on a plurality of discrete computing devices via distributed computing network (e.g., network 20). Examples of network 20 may include but are not limited to the Internet, a local area network, or a wide area network. Network 14 may be connected to one or more secondary networks (not shown) or may be a portion of a larger network.

For this example and for illustrative purposes only, asset exchange process 10 is shown to be implemented on six computing devices (e.g., computing devices 22, 24, 26, 28, 30, 32) that are coupled via network 20, wherein each of computing devices 22, 24, 26, 28, 30, 32 may implement some or all of asset exchange process 10. Examples of computing devices 22, 24, 26, 28, 30, 32 may include, but are not limited to: a personal computer, a laptop computer, a notebook computer, a personal digital assistant, a smartphone, a server computer, a series of server computers, a mini computer, a mainframe computer, or a cloud-based computing network.

While in this particular example, asset exchange process 10 is shown to be implemented on six computing devices (e.g., computing devices 22, 24, 26, 28, 30, 32), this is for illustrative purposes only and is not intended to be a limitation of this disclosure, as other configurations are possible. For example, it is understood that the number of computing devices that implement asset exchange process 10 may be increased or decreased depending upon the specific needs, specific requirements and/or design criteria of asset exchange process 10.

Continuing with the above-stated example:
computing device 22 may implement a portion of asset exchange process 10 (e.g., asset exchange process 10a), wherein the instruction sets and subroutines of asset exchange process 10a, which may be stored on storage device 34 coupled to computing device 22, may be executed by one or more processors (not shown) and one or more memory architectures (not shown) included within computing device 22;
computing device 24 may implement a portion of asset exchange process 10 (e.g., asset exchange process 10b), wherein the instruction sets and subroutines of asset exchange process 10b, which may be stored on storage device 36 coupled to computing device 24, may be executed by one or more processors (not shown) and one or more memory architectures (not shown) included within computing device 24;
computing device 26 may implement a portion of asset exchange process 10 (e.g., asset exchange process 10c), wherein the instruction sets and subroutines of asset exchange process 10c, which may be stored on storage device 38 coupled to computing device 26, may be executed by one or more processors (not shown) and one or more memory architectures (not shown) included within computing device 26;
computing device 28 may implement a portion of asset exchange process 10 (e.g., asset exchange process 10d), wherein the instruction sets and subroutines of asset exchange process 10d, which may be stored on storage device 40 coupled to computing device 28, may be executed by one or more processors (not shown) and one or more memory architectures (not shown) included within computing device 28;
computing device 30 may implement a portion of asset exchange process 10 (e.g., asset exchange process 10e), wherein the instruction sets and subroutines of asset exchange process 10e, which may be stored on storage device 42 coupled to computing device 30, may be executed by one or more processors (not shown) and one or more memory architectures (not shown) included within computing device 30; and
computing device 32 may implement a portion of asset exchange process 10 (e.g., asset exchange process 10f), wherein the instruction sets and subroutines of asset exchange process 10f, which may be stored on storage device 44 coupled to computing device 32, may be executed by one or more processors (not shown) and one or more memory architectures (not shown) included within computing device 32.

Examples of storage devices 34, 36, 38, 40, 42, 44 may include but are not limited to: a hard disk drive; a RAID device; a random access memory (RAM); a read-only memory (ROM); and all forms of flash memory storage devices. Computing devices 22, 24, 26, 28, 30, 32 may each execute an operating system, examples of which may include but are not limited to Microsoft Windows™, Android™, WebOS™, iOS™, macOS™, Redhat Linux™, or a custom operating system.

The various computing devices (e.g., computing devices 22, 24, 26, 28, 30, 32) may be directly or indirectly coupled to network 20. For example, one or more of computing devices 22, 24, 26, 28, 30, 32 may be directly coupled to network 20 via a hardwired connection between one or more of computing devices 22, 24, 26, 28, 30, 32 and network 20. Additionally, one or more of computing devices 22, 24, 26, 28, 30, 32 may be wirelessly coupled to network 20 via a wireless communication channel (not shown) established between one or more of computing devices 22, 24, 26, 28, 30, 32 and a cellular network/wireless access point (not shown), which may be directly coupled to network 20.

### Asset Exchange Process:

As stated above, asset exchange process 10 may be configured to effectuate an asset exchange between a plurality of banks. Further and as discussed above, examples of such a plurality of banks may include but are not limited to commercial bank 12, commercial bank 14, commercial bank 16, commercial bank 18.

For the following example, assume that commercial bank 12 wishes to transfer assets to commercial bank 18 and, therefore, commercial bank 12 may initiate an asset exchange (e.g., asset exchange 46) to effectuate the transfer of such assets. Asset exchange 46 may be an international asset exchange between a first country (e.g., Country/Region 48) and a second country (e.g., Country/Region 50). Accordingly, the plurality of banks may include a first commercial bank (e.g., commercial bank 12) in the first country (e.g., Country/Region 48) and a second commercial bank (e.g., commercial bank 18) in the second country (e.g., Country/Region 50).

For this example, assume that a customer of commercial bank 12 (e.g., a US-based commercial bank) wishes to transfer assets 52 (e.g., in US dollars) to a customer of commercial bank 18 (e.g., an India-based commercial bank) as assets 54 (in Indian Rupees).

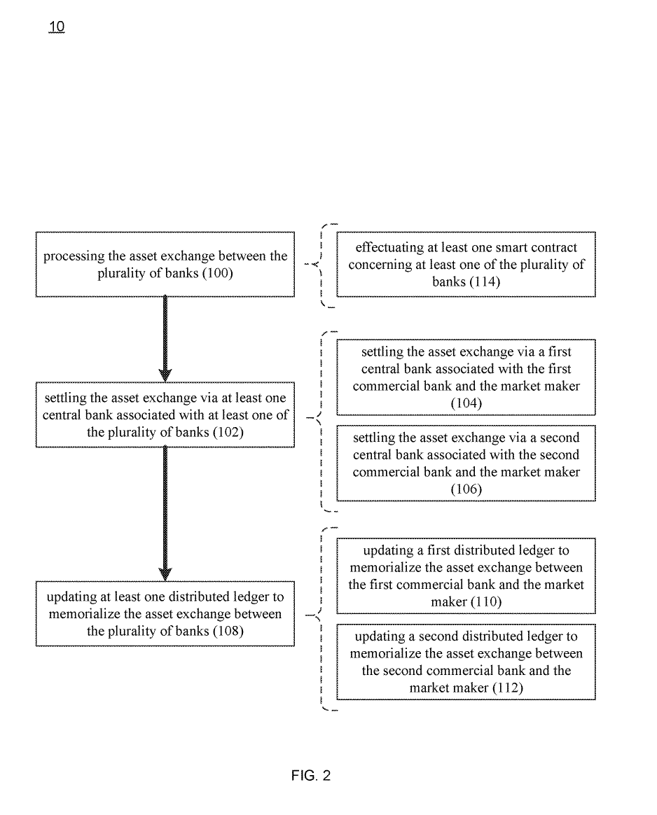

Accordingly and referring also to FIG. 2, asset exchange process 10 may process 100 asset exchange 46 between the plurality of banks (e.g., commercial bank 12 and commercial bank 18) and may settle 102 asset exchange 46 via at least one central bank associated with at least one of the plurality of banks (e.g., commercial bank 12 and commercial bank 18).

For example, assume that central bank 56 is associated with commercial bank 12, commercial bank 14 and commercial bank 58. Accordingly, central bank 56 may be configured to effectuate settlement of exchanges between member banks (e.g., commercial banks 12, 14, 58). As is known in the art, a central bank (e.g., central bank 56) may be a monetary authority (e.g., a monopolized or nationalized institution) that controls the production and distribution of money and credit. In modern economies, a central bank (e.g., central bank 56) may be responsible for the formulation of monetary policy and the regulation of member banks (e.g., commercial banks 12, 14, 58). As commercial bank 12 (in this example) is a US-based commercial bank, an example of central bank 56 may include the United States Federal Reserve System, wherein central bank 56 may be configured to effectuate account-based transfers between member banks (e.g., commercial banks 12, 14, 58). Specifically, central bank 56 may be configured to maintain individual accounts for member banks (e.g., commercial banks 12, 14, 58), wherein asset transfers (in US dollars) from one member bank to another member bank may be effectuated by debiting the account of the transferring member bank a defined quantity of US dollars and crediting the account of the receiving member bank the same defined quantity of US dollars.

Further, assume that central bank 60 is associated with commercial bank 16, commercial bank 18 and commercial bank 62. Accordingly, central bank 60 may be configured to effectuate settlement of exchanges between member banks (e.g., commercial banks 16, 18, 62). As commercial bank 18 (in this example) is an India-based commercial bank, an example of central bank 60 may include the Reserve Bank of India, wherein central bank 60 may be configured to effectuate account-based transfers between member banks (e.g., commercial banks 16, 18, 62). Specifically, central bank 60 may be configured to maintain individual accounts for member banks (e.g., commercial banks 16, 18, 62), wherein asset transfers (in Indian Rupees) from one member bank to another member bank may be effectuated by debiting the account of the transferring member bank a defined quantity of Indian Rupees and crediting the account of the receiving member bank the same defined quantity of Indian Rupees.

As discussed above, asset exchange 46 may be an international asset exchange between a first country (e.g., Country/Region 48) and a second country (e.g., Country/Region 50). When effectuating such an international asset exchange, at least one of the plurality of banks (e.g., commercial banks 12, 14, 16, 18) may be a market maker (e.g., a trader/dealer that maintains bank accounts in multiple countries) that allows for asset exchanges between the first country (e.g., Country/Region 48) and the second country (e.g., Country/Region 50).

Continuing with the above-stated example in which commercial bank 12 wishes to transfer assets to commercial bank 18, assume that commercial bank 14 and commercial bank 16 are related, in that commercial bank 14 is the US-based portion of international bank 64 and commercial bank 16 is the Indian-based portion of international bank 64. Accordingly, the combination of commercial bank 14 (the US-based portion of international bank 64) and commercial bank 16 (the Indian-based portion of international bank 64) may function as a market maker to allow for asset exchanges between (in this example) the United States of America and India. Other examples of such a market maker may include but is not limited to a bank that maintains a nostro account, wherein a nostro account is an account that allows a bank of a first country to maintain an account that holds and trades the currency of a second country; or a trader/dealer that maintains bank accounts in multiple countries.

Continuing with the above-stated example, assume that commercial bank 12 (e.g., a US-based commercial bank) wishes to transfer assets 52 (e.g., $10,000 US dollars) to commercial bank 18 (e.g., an Indian-based commercial bank) as assets 54. As commercial bank 18 is an Indian-based commercial bank, transferred assets 52 (e.g., $10,000 US dollars) cannot be directly transferred to commercial bank 18 and must first be converted to assets 54 (e.g., Indian Rupees). Accordingly, international bank 64 (e.g., commercial bank 14 and commercial bank 16) may be utilized by asset exchange process 10 to function as a market maker and effectuate the transfer.

Accordingly, asset exchange process 10 may process 100 asset exchange 46 between the plurality of banks (e.g., commercial bank 12 and commercial bank 18) and may settle 102 asset exchange 46 via at least one central bank associated with at least one of the plurality of banks (e.g., commercial bank 12 and commercial bank 18).

As will be discussed below in greater detail, when settling 102 the asset exchange via at least one central bank associated with at least one of the plurality of banks, asset exchange process 10 may settle 104 the asset exchange (e.g., asset exchange 46) via a first central bank (e.g., central bank 56) associated with the first commercial bank (e.g., commercial bank 12) and the third commercial bank (e.g., commercial bank 14 of international bank 64); and may settle 106 the asset exchange (e.g., asset exchange 46) via a second central bank (e.g., central bank 60) associated with the second commercial bank (e.g., commercial bank 18) and the third commercial bank (e.g., commercial bank 16 of international bank 64).

Accordingly and when processing 100 asset exchange 46, asset exchange process 10 may arrange to have $10,000 US dollars transferred from commercial bank 12 to commercial bank 14 via central bank 56.

As discussed, central bank 56 (which is associated with commercial bank 12, commercial bank 14 and commercial bank 58) may be configured to effectuate settlement of exchanges between member banks (e.g., commercial banks 12, 14, 58). Accordingly and when processing 100 asset exchange 46, asset exchange process 10 may utilize central bank 56 to settle 104 the $10,000 account-based transfer from commercial bank 12 to commercial bank 14 by debiting the account of commercial bank 12 by $10,000 while crediting the account of commercial bank 14 by $10,000.

Since international bank 64 (e.g., commercial bank 14 and commercial bank 16) may be utilized (in this example) by asset exchange process 10 to function as a market maker and effectuate the currency exchange, upon the account associated with commercial bank 14 being credited $10,000 from commercial bank 12, asset exchange process 10 may convert this $10,000 into Indian Rupees (which currently converts to 640,700 Rupees). Accordingly, asset exchange process 10 may credit an account within central bank 60 that is associated with commercial bank 16 by 640,700 Rupees while debiting the account within central bank 56 that is associated with commercial bank 14 by $10,000.

In order to complete the $10,000 transfer from commercial bank 12 to commercial bank 18 (and upon the account within central bank 60 that is associated with commercial bank 16 being credited 640,700 Rupees), asset exchange process 10 may utilize central bank 60 to settle 106 the 640,700 Rupees account-based transfer from commercial bank 16 to commercial bank 18 by debiting the account of commercial bank 16 by 640,700 Rupees while crediting the account of commercial bank 18 by 640,700 Rupees.

Ledgering:

Asset exchange process 10 may update 108 at least one distributed ledger (e.g., ledger 66 and/or ledger 68) to memorialize asset exchange 46 between the plurality of banks (e.g., commercial bank 12 and commercial bank 18). One example of such a distributed ledger (e.g., ledger 66 and/or ledger 68) may include but is not limited to a blockchain ledger.

As is known in the art, a blockchain ledger may be a continuously growing list of records (e.g., called blocks) that are linked and secured using cryptography. For example, each block within a blockchain may contain a hash pointer as a link to a previous block. Accordingly, blockchains may be inherently resistant to modification of the data, as each block in the chain is linked (via a hash function) to the previous block in the chain. Accordingly, a block may include transaction data, a hash function that identifies the previous block in the blockchain ledger, and a time/date stamp. Functionally, a blockchain ledger may serve as an open, distributed ledger that may securely record transactions between two parties (e.g., commercial banks) efficiently and in a verifiable and permanent way.

As will be explained below in greater detail, when updating 108 at least one distributed ledger (e.g., ledger 66 and/or ledger 68) to memorialize asset exchange 46 between the plurality of banks (e.g., commercial bank 12 and commercial bank 18), asset exchange process 10 may update 110 a first distributed ledger (e.g., ledger 66) to memorialize the asset exchange between the first commercial bank (e.g., commercial bank 12) and the third commercial bank (e.g., commercial bank 14 of international bank 64), and may update 112 a second distributed ledger (e.g., ledger 68) to memorialize the asset exchange between the second commercial bank (e.g., commercial bank 18) and the third commercial bank (e.g., commercial bank 16 of international bank 64).

Accordingly, asset exchange process 10 may update 110 ledger 66 to memorialize the asset exchange between commercial bank 12 and commercial bank 14 (of international bank 64). Specifically and in the manner described above, asset exchange process 10 may update 110 ledger 66 to include a new block, wherein this new block may include transaction data (e.g., $10,000 as the transfer amount, commercial bank 12 as the transferor, and commercial bank 14 as the transferee), a time/date stamp for the transaction, and a copy of the hash of the previous block in the blockchain ledger. Asset exchange process 10 may then generate a hash of this new block for use within the next block in the blockchain.

As this is a distributed ledger system, a copy of ledger 66 may be calculated and maintained by all interested parties (e.g., commercial banks 12, 14, 58) on computing devices 22, 26, 24 (respectively), wherein each of the interested parties (e.g., commercial banks 12, 14, 58) must compare their newly-calculated block and confirm identical results before the newly-calculated block is added to (in this example) ledger 66.

Further, asset exchange process 10 may update 112 ledger 68 to memorialize the asset exchange between commercial bank 18 and commercial bank 16 (of international bank 64). Specifically and in the manner described above, asset exchange process 10 may update 112 ledger 68 to include a new block, wherein this new block may include transaction data (e.g., 640,700 Rupees as the transfer amount, commercial bank 16 as the transferor, and commercial bank 18 as the transferee), a time/date stamp for the transaction, and a copy of the hash of the previous block in the blockchain ledger. Asset exchange process 10 may then generate a hash of this new block for use within the next block in the blockchain.

As this is a distributed ledger system, a copy of ledger 68 may be calculated and maintained by all interested parties (e.g., commercial banks 16, 18, 62) on computing devices 28, 32, 30 (respectively), wherein each of the interested parties (e.g., commercial banks 16, 18, 62) must compare their newly-calculated block and confirm identical results before the newly-calculated block is added to (in this example) ledger 68.

Smart Contracts:

When processing 100 asset exchange 50 between the plurality of banks (e.g., commercial bank 12 and commercial bank 18), asset exchange process 10 may effectuate 114 at least one smart contract (e.g., smart contracts 70, 72) concerning at least one of the plurality of banks (e.g., commercial bank 12 and commercial bank 18).

Often, the various parties in a transaction (e.g., commercial banks 12, 14, 16, 18) may not know each other and may not trust each other. Accordingly, one or more smart contracts (e.g., smart contracts 70, 72) may be utilized to provide a higher level of security and trust when effectuating asset exchange 46. Specifically and as is known in the art, smart contracts (e.g., smart contracts 70, 72) may be computer protocols intended to facilitate, verify and/or enforce the negotiation and/or performance of all or a portion of a contract. Through the use of such smart contracts (e.g., smart contracts 70, 72), various contractual clauses may be made partially (or fully) self-executing and/or self-enforcing.

Accordingly and when processing 100 asset exchange 46 between the plurality of banks (e.g., commercial bank 12 and commercial bank 18), asset exchange process 10 may effectuate 114 smart contract 70 concerning commercial bank 12 that may be utilized to control e.g., the transfer of assets between commercial bank 12 and commercial bank 14.

Further and when processing 100 asset exchange 50 between the plurality of banks (e.g., commercial bank 12 and commercial bank 18), asset exchange process 10 may effectuate 114 smart contract 72 concerning commercial bank 18 that may be utilized to control e.g., the transfer of assets between commercial bank 16 and commercial bank 18.

Additionally and in some implementations, a third smart contract (e.g., smart contract 74) may be utilized to control e.g., the transfer of assets between commercial bank 14 and commercial bank 16.

Smart contracts 70, 72, 74 may be linked together so that the execution of one smart contract automatically triggers the execution of the other smart contracts (and vice versa). Accordingly the presence of smart contracts 70, 72, 74 may be known to (and reviewable by) asset exchange process 10. Accordingly and prior to effecting any portions of the above-described transfer (e.g., commercial bank 12 to commercial bank 14, commercial bank 14 to commercial bank 16 and/or commercial bank 16 to commercial bank 18), asset exchange process 10 may examine smart contracts 70, 72, 74 to ensure their presence and proper configuration. Further and when processing 100 asset exchange 50 between the plurality of banks (e.g., commercial bank 12 and commercial bank 18), asset exchange process 10 may effectuate 114 smart contracts 70, 72, 74 to ensure that all parties execute the transfers required to fully effectuate asset exchange 46. Accordingly and through the use of such smart contracts (e.g., smart contracts 70, 72, 74), situations may be avoided where one commercial bank fails to effectuate their transfer (e.g., commercial bank 14 receives $10,000 from commercial bank 12 but fails to transfer 640,700 Rupees to commercial bank 16).

Distributed Account Ledgers:

As discussed above, central bank 56 may be associated with commercial bank 12, commercial bank 14 and commercial bank 58, wherein central bank 56 may be configured to effectuate settlement of exchanges between member banks (e.g., commercial banks 12, 14, 58). Accordingly, central bank 56 may be configured to maintain individual accounts for member banks (e.g., commercial banks 12, 14, 58), wherein asset transfers (in US dollars) from one member bank to another member bank may be effectuated by debiting the account of the transferring member bank a defined quantity of US dollars and crediting the account of the receiving member bank the same defined quantity of US dollars.

Central bank 56 may maintain an account ledger (e.g., account ledger 76) that identifies the individual accounts maintained by central bank 56 for the member banks (e.g., commercial banks 12, 14, 58) and identifies the quantity of assets included in each of those individual accounts. Unfortunately, in the event that central bank 56 is offline (e.g., due to a hardware failure, a software failure, or a virus/malware/hacking event), account ledger 76 may not be updated and, therefore, settlement of exchanges between member banks (e.g., commercial banks 14, 16, 58) may not occur.

Further and as discussed above, central bank 60 may be associated with commercial bank 16, commercial bank 18 and commercial bank 62, wherein central bank 60 may be configured to effectuate settlement of exchanges between member banks (e.g., commercial banks 16, 18, 62). Accordingly, central bank 60 may be configured to maintain individual accounts for member banks (e.g., commercial banks 16, 18, 62), wherein asset transfers (in Indian Rupees) from one member bank to another member bank may be effectuated by debiting the account of the transferring member bank a defined quantity of Indian Rupees and crediting the account of the receiving member bank the same defined quantity of Indian Rupees.

Central bank 60 may maintain an account ledger (e.g., account ledger 78) that identifies the individual accounts maintained by central bank 60 for the member banks (e.g., commercial banks 16, 18, 62) and identifies the quantity of assets included in each of those individual accounts. Unfortunately, in the event that central bank 60 is offline (e.g., due to a hardware failure, a software failure, or a virus/malware/hacking event), account ledger 78 may not be updated and, therefore, settlement of exchanges between member banks (e.g., commercial banks 16, 18, 62) may not occur.

In order to provide a higher level of availability, asset exchange process 10 may be configured to utilize a distributed ledger process with respect to account ledger 76 and/or account ledger 78 (in a manner similar to that utilized for ledgers 66, 68). An example of such a distributed ledger process may include but is not limited to a blockchain ledgering process.

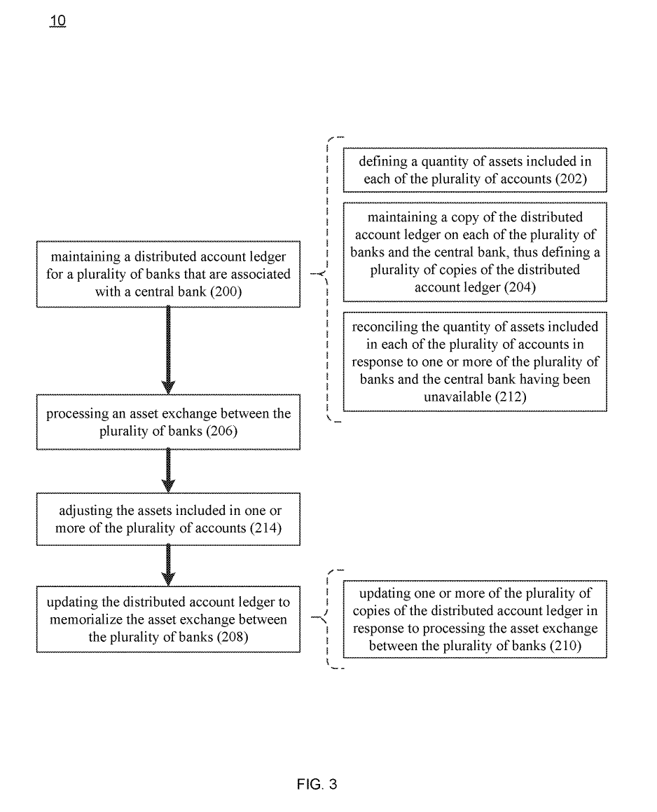

For the following example, assume that commercial bank 12 (e.g., a US-based bank) wishes to transfer assets 52 (e.g., $100,000 US dollars) to commercial bank 58 (e.g., a US-based commercial bank). Accordingly and referring also to FIG. 3, asset exchange process 10 may maintain 200 a distributed account ledger (e.g., account ledger 76) for a plurality of banks (e.g., commercial banks 12, 14, 58) that are associated with a central bank (e.g., central bank 56).

As discussed above, central bank 56 may maintains an account for each of the plurality of banks (e.g., commercial banks 12, 14, 58), thus defining a plurality of accounts (e.g., plurality of accounts 80). Accordingly and when maintaining 200 the distributed account ledger (e.g., account ledger 76) for the plurality of banks (e.g., commercial banks 12, 14, 58) that are associated with the central bank (e.g., central bank 56), asset exchange process 10 may define 202 a quantity of assets included in each of the plurality of accounts (e.g., plurality of accounts 80).

Further and when maintaining 200 the distributed account ledger (e.g., account ledger 76) for the plurality of banks (e.g., commercial banks 12, 14, 58) that are associated with the central bank (e.g., central bank 56), asset exchange process 10 may maintain 204 a copy of the distributed account ledger (e.g., account ledger 76) on each of the plurality of banks (e.g., commercial banks 12, 14, 58) and the central bank (e.g., central bank 56), thus defining a plurality of copies of the distributed account ledger (e.g., account ledger 76).

For the following example, assume that plurality of accounts 80 includes three accounts, namely one for commercial bank 12, one for commercial bank 14 and one for commercial bank 58. Further assume for the following example that: the account (included within plurality of accounts 80) that is associated with commercial bank 12 initially defines assets of $10,000,000; the account (included within plurality of accounts 80) that is associated with commercial bank 14 initially defines assets of $20,000,000; and the account (included within plurality of accounts 80) that is associated with commercial bank 58 initially defines assets of $5,000,000.

As will be explained below in greater detail, asset exchange process 10 may process 206 an asset exchange (e.g., asset exchange 82) between the plurality of banks (e.g., commercial banks 12, 14, 58) and may update 208 the distributed account ledger (e.g., account ledger 76) to memorialize the asset exchange (e.g., asset exchange 82) between the plurality of banks (e.g., commercial banks 12, 14, 58).

Continuing with the above-stated example, asset exchange 82 may define an asset transfer of $100,000 (e.g., assets 52) from commercial bank 12 (e.g., a US-based bank) to commercial bank 58 (e.g., a US-based commercial bank). Accordingly and when asset exchange process 10 processes 206 asset exchange 82, commercial banks 12, 14, 58 and central bank 56 may all receive and process asset exchange 82. For example and when processing 206 asset exchange 82, each of commercial banks 12, 14, 58 and central bank 56 may review their copy of asset exchange 82 (which defines, in this example, a $100,000 transfer from commercial bank 12 to commercial bank 58).

Additionally and when processing 206 asset exchange 82, each of commercial banks 12, 14, 58 and central bank 56 may review their copy of the distributed account ledger (e.g., account ledger 76), which (as discussed above) identifies the individual accounts maintained by central bank 56 for the member banks (e.g., commercial banks 12, 14, 58) and identifies the quantity of assets included in each of plurality of accounts 80. Accordingly and by examining asset exchange 82 with respect to account ledger 76, asset exchange process 10 may be able to determine whether asset exchange 82 should be processed 206.

As discussed above, the account (included within plurality of accounts 80) that is associated with commercial bank 12 initially defines assets of $10,000,000; and asset exchange 82 defines (in this example) a $100,000 transfer from commercial bank 12 to commercial bank 58. According and since commercial bank 12 has sufficient funds in their account to effectuate the $100,000 transfer from commercial bank 12 to commercial bank 58, asset exchange process 10 may process 206 asset exchange 82 and each of commercial banks 12, 14, 58 and central bank 56 may recalculate the asset balances defined within account ledger 76.

Accordingly, each of commercial banks 12, 14, 58 and central bank 56 may recalculate the asset balances defined within account ledger 76 as follows: the account (included within plurality of accounts 80) that is associated with commercial bank 12 will now define assets of $9,900,000 (due to the outbound transfer of $100,000 to commercial bank 58); the account (included within plurality of accounts 80) that is associated with commercial bank 14 will remain unchanged and define assets of $20,000,000; and the account (included within plurality of accounts 80) that is associated with commercial bank 58 will now define assets of $5,100,000 (due to the inbound transfer of $100,000 from commercial bank 12).

As this is a distributed ledger system, each of the interested parties (e.g., commercial banks 12, 14, 58 and central bank 56) must compare these calculations and confirm identical results before updating 208 the distributed account ledger (e.g., account ledger 76).

When updating 208 the distributed account ledger (e.g., account ledger 76) to memorialize the asset exchange (e.g., asset exchange 82) between (in this example) commercial bank 12 and commercial bank 58, asset exchange process 10 may update 210 one or more of the plurality of copies (namely the copies stored on commercial bank 12, commercial bank 14, commercial bank 58 and/or central bank 56) of the distributed account ledger (e.g., account ledger 76) in response to the processing 206 of asset exchange 82.

As discussed above, one example of a distributed ledger (e.g., ledger 76 and/or ledger 78) may include but is not limited to a blockchain ledger. Further and as discussed above, a blockchain ledger may be a continuously growing list of records (e.g., called blocks) that are linked and secured using cryptography. Accordingly, a block may include transaction data, a hash function that identifies the previous block in the blockchain ledger, and a time/date stamp.

Accordingly and when updating 208 the distributed account ledger (e.g., account ledger 76) to memorialize the asset exchange between (in this example) commercial bank 12 and commercial bank 58, asset exchange process 10 may update 210 ledger 76 to include a new block, wherein this new block may include transaction data that defines e.g., the above-described asset balances defined within account ledger 76, a time/date stamp for the transaction, and a copy of the hash of the previous block in the blockchain ledger. Asset exchange process 10 may then generate a hash of this new block for use within the next block in the blockchain.

Typically and when updating 208 the distributed account ledger (e.g., account ledger 76) to memorialize the asset exchange (e.g., asset exchange 82), all copies of the distributed account ledger (e.g., account ledger 76) may be updated. However and as discussed above, the use of a distributed account ledger (e.g., account ledger 76) is to provide a level of high availability to account ledger 76. Unfortunately and without such high availability, in the event that central bank 56 is offline (e.g., due to a hardware failure, a software failure, or a virus/malware/hacking event), account ledger 76 may not be updated and, therefore, settlement of exchanges between member banks (e.g., commercial banks 16, 18, 62) would not occur.

Accordingly and in order to provide such a high level of availability, in the event that one of the interested parties (e.g., commercial banks 12, 14, 58 and central bank 56) is not online, when updating 208 the distributed account ledger (e.g., account ledger 76) to memorialize the asset exchange (e.g., asset exchange 82), some of the copies of the distributed account ledger (e.g., account ledger 76) may not be updated.

For example and assuming that central bank 56 is offline due to a malware attack, when processing 206 asset exchange 82, each of commercial banks 12, 14, 58 may review their copy of asset exchange 82 and may review their copy of the distributed account ledger (e.g., account ledger 76) so that asset exchange process 10 may determine whether or not asset exchange 82 should be processed 206. As the account (included within plurality of accounts 80) that is associated with commercial bank 12 initially defines assets of $10,000,000 and asset exchange 82 defines (in this example) a $100,000 transfer from commercial bank 12 to commercial bank 58, asset exchange process 10 may process 206 asset exchange 82 and each of commercial banks 12, 14, 58 may recalculate the asset balances defined within account ledger 76.

Since central bank 56 was offline due to a malware attack, the copy of account ledger 76 stored on central bank 56 would be out-of-date with respect to the copies of account ledger 76 stored on commercial bank 12, commercial bank 14 and commercial bank 58 (as it would not reflect the transaction defined within asset exchange 82).

Accordingly and when maintaining 200 the distributed account ledger (e.g., account ledger 76) for the plurality of banks (e.g., commercial banks 12, 14, 58) that are associated with the central bank (e.g., central bank 56), asset exchange process 10 may reconcile 212 the quantity of assets included in each of the plurality of accounts 80 in response to one or more of the plurality of banks and the central bank having been unavailable.

Accordingly and when (in this example) central bank 56 comes back online, central bank 56 may compare their copy of account ledger 76 to the copies of account ledger 76 that are stored on commercial banks 12, 14, 58 and may determine that the copy of account ledger 76 that is stored on central bank 56 is different from the copies of account ledger 76 that are stored on commercial banks 12, 14, 58 (which are all identical). According, asset exchange process 10 may: reconcile 212 the quantity of assets included in each of the plurality of accounts 80 to match the quantities defined within the copies of account ledger 76 stored on commercial banks 12, 14, 58: and may update their copy of account ledger 76 in the manner described above.

As discussed above, prior to processing a particular asset exchange, the interested parties (e.g., commercial banks 12, 14, 58 and central bank 56) may determine whether or not the transferring party has sufficient funds to effectuate the transfer, wherein the asset exchange is only processed in the event that sufficient funds exist.

Accordingly and in the event that sufficient funds do not exist, asset exchange process 10 may adjust 214 the assets included in one or more of plurality of accounts 80. For example, if the account associated with commercial bank 12 did not have enough assets to effectuate an asset exchange, asset exchange process 10 may (automatically or in response to an inquiry) adjust 214 the assets included within the account associated with commercial bank 12 upward so that the particular asset exchange may be covered. Asset exchange process 10 may subsequently adjust 214 the assets included in the account associated with commercial bank 12 downward at a future date when the additional assets are no longer needed (in a manner similar to a short term loan). Further, this adjustment 214 of assets by asset exchange process 10 need not be in response to a shortage of funds needed to effectuate a particular asset exchange. For example, this adjustment 214 of assets by asset exchange process 10 may be in response to e.g., a particular commercial bank asking for additional liquidity due to a desire to provide additional lending.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
maintaining a distributed account ledger for a plurality of banks that are associated with a central bank;
processing an asset exchange between the plurality of banks; and
updating the distributed account ledger to memorialize the asset exchange between the plurality of banks.

2. The computer implemented method of claim 1 wherein maintaining a distributed account ledger for the plurality of banks that are associated with the central bank includes:
maintaining a copy of the distributed account ledger on each of the plurality of banks and the central bank, thus defining a plurality of copies of the distributed account ledger.

3. The computer implemented method of claim 1 wherein updating the distributed account ledger to memorialize the asset exchange between the plurality of banks includes:
updating one or more of the plurality of copies of the distributed account ledger in response to processing the asset exchange between the plurality of banks.

4. The computer implemented method of claim 1 wherein the central bank maintains an account for each of the plurality of banks, thus defining a plurality of accounts.

5. The computer implemented method of claim 4 further comprising:
adjusting the assets included in one or more of the plurality of accounts.

6. The computer implemented method of claim 4 wherein maintaining a distributed account ledger for the plurality of banks that are associated with the central bank includes:
defining a quantity of assets included in each of the plurality of accounts.

7. The computer implemented method of claim 4 wherein maintaining a distributed account ledger for the plurality of banks that are associated with the central bank includes:
reconciling the quantity of assets included in each of the plurality of accounts in response to one or more of the plurality of banks and the central bank having been unavailable.

8. The computer-implemented method of claim 1 wherein the plurality of banks includes at least one commercial bank.

9. The computer implemented method of claim 1 wherein the distributed account ledger includes a blockchain ledger.

10. A computer program product residing on a computer readable medium having a plurality of instructions stored thereon which, when executed by a processor, cause the processor to perform operations comprising:
maintaining a distributed account ledger for a plurality of banks that are associated with a central bank;
processing an asset exchange between the plurality of banks; and
updating the distributed account ledger to memorialize the asset exchange between the plurality of banks.

11. The computer program product of claim 10 wherein maintaining a distributed account ledger for the plurality of banks that are associated with the central bank includes:
maintaining a copy of the distributed account ledger on each of the plurality of banks and the central bank, thus defining a plurality of copies of the distributed account ledger.

12. The computer program product of claim 10 wherein updating the distributed account ledger to memorialize the asset exchange between the plurality of banks includes:
updating one or more of the plurality of copies of the distributed account ledger in response to processing the asset exchange between the plurality of banks.

13. The computer program product of claim 10 wherein the central bank maintains an account for each of the plurality of banks, thus defining a plurality of accounts.

14. The computer program product of claim 13 further comprising:
adjusting the assets included in one or more of the plurality of accounts.

15. The computer program product of claim 13 wherein maintaining a distributed account ledger for the plurality of banks that are associated with the central bank includes:
defining a quantity of assets included in each of the plurality of accounts.

16. The computer program product of claim 13 wherein maintaining a distributed account ledger for the plurality of banks that are associated with the central bank includes:
reconciling the quantity of assets included in each of the plurality of accounts in response to one or more of the plurality of banks and the central bank having been unavailable.

17. The computer program product of claim 10 wherein the plurality of banks includes at least one commercial bank.

18. The computer program product of claim 10 wherein the distributed account ledger includes a blockchain ledger.

19. A computing system including a processor and memory configured to perform operations comprising:
maintaining a distributed account ledger for a plurality of banks that are associated with a central bank;
processing an asset exchange between the plurality of banks; and
updating the distributed account ledger to memorialize the asset exchange between the plurality of banks.

20. The computing system of claim 18 wherein maintaining a distributed account ledger for the plurality of banks that are associated with the central bank includes:
maintaining a copy of the distributed account ledger on each of the plurality of banks and the central bank, thus defining a plurality of copies of the distributed account ledger.

21. The computing system of claim 18 wherein updating the distributed account ledger to memorialize the asset exchange between the plurality of banks includes:
updating one or more of the plurality of copies of the distributed account ledger in response to processing the asset exchange between the plurality of banks.

22. The computing system of claim 18 wherein the central bank maintains an account for each of the plurality of banks, thus defining a plurality of accounts.

23. The computing system of claim 22 further configured to perform operations comprising:
adjusting the assets included in one or more of the plurality of accounts.

24. The computing system of claim 22 wherein maintaining a distributed account ledger for the plurality of banks that are associated with the central bank includes:
defining a quantity of assets included in each of the plurality of accounts.

25. The computing system of claim 22 wherein maintaining a distributed account ledger for the plurality of banks that are associated with the central bank includes:
reconciling the quantity of assets included in each of the plurality of accounts in response to one or more of the plurality of banks and the central bank having been unavailable.

26. The computing system of claim 19 wherein the plurality of banks includes at least one commercial bank.

27. The computing system of claim 19 wherein the distributed account ledger includes a blockchain ledger.
